(19) United States
(12) Patent Application Publication
(10) Pub. No.: US 2009/0114248 A1
(43) Pub. Date: May 7, 2009

(54) Substrate treating apparatus and method for treating substrate using the substrate treating apparatus

(76) Inventor: Seong-Soo Kim, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/290,400

(22) Filed: Oct. 30, 2008

(30) Foreign Application Priority Data
Nov. 5, 2007 (KR) 2007-112251

(51) Int. Cl. B08B 3/02

(52) U.S. Cl. 134/7; 134/99.1

(57) ABSTRACT

A substrate treating apparatus includes an injecting nozzle which injects a treating solution to dry a substrate. The injecting nozzle discharges the treating solution to the substrate and injects a treating gas to the treating solution discharged from the injecting nozzle by controlling a stream of the treating gas. Thus, since the substrate treating apparatus can minimize a size of a minor particle of the treating solution, a cleaning efficiency and a yield of a product may be improved.

### CROSS-REFERENCE TO RELATED APPLICATION

This U.S. non-provisional patent application claims priority under 35 U.S.C. §119 of Korean Patent Application No. 10-2007-0112251, filed on Nov. 5, 2007, the entire contents of which are herein incorporated by reference in their entirety.

### BACKGROUND

The present invention disclosed herein relates to an apparatus for manufacturing a semiconductor substrate, and more particularly, to a chemical solution treatment apparatus providing a chemical solution for treating a semiconductor substrate and a method for cleaning the semiconductor substrate.

Generally, semiconductor devices are manufactured by repeating deposition, etching and cleaning processes. Particularly, wet etching and cleaning processes treat a semiconductor substrate using various chemical solutions.

When a semiconductor substrate is dried using isopropyl alcohol, a chemical solution nozzle for injecting isopropyl alcohol and a gas nozzle for injecting nitrogen gas are disposed on upper portion of the semiconductor substrate, respectively. The semiconductor substrate is dried by isopropyl alcohol and nitrogen gas discharged from the chemical solution nozzle and the gas nozzle, respectively. However, since the chemical solution nozzle and the gas nozzle are separately provided and isopropyl alcohol and nitrogen gas are linearly injected from the respective nozzles to the semiconductor substrate, the isopropyl alcohol and nitrogen gas are not well mixed. Therefore, a cleaning efficiency of a semiconductor substrate is deteriorated.

### SUMMARY

Exemplary embodiments provide a substrate treating apparatus. The substrate treating apparatus includes a supporting member and a treating solution supplying portion. A substrate is fixedly disposed on the supporting member. The treating solution supplying portion is disposed above the supporting member and dries the substrate by injecting a treating solution in the shape of a minute particle on the substrate disposed on the supporting member. The treating solution supplying portion includes a first supplying nozzle, a second supplying nozzle and an injecting nozzle. The first supplying nozzle receives the treating solution. The second supplying nozzle receives a treating gas. The injecting nozzle simultaneously discharges the treating gas and the treating solution by controlling a stream of the treating gas to decompose the treating solution into a minor particle through the treating gas. The injecting nozzle includes a chemical solution flow path in which the treating solution is injected from the first supplying nozzle, and a gas flow path which surrounds the chemical solution flow path and in which the treating gas is injected from the second supplying nozzle.

Exemplary embodiments provide a method of treating a substrate. The method is as follows. A substrate is fixedly disposed on a supporting member and an injection nozzle is disposed on an upper portion of the supporting member. The injecting nozzle injects the treating solution in the shape of a minute particle to the substrate to dry the substrate. A process of drying the substrate is as follows. A treating gas is injected into a gas flow path of the injecting nozzle surrounding the chemical solution flow path and the treating solution is injected into a chemical flow path of the injecting nozzle. A stream of the treating gas which is injected in the gas flow path is controlled to discharge the treating gas to the substrate and the treating solution of the chemical solution flow path is discharged to the substrate to decompose the treating solution in the shape of a minute particle.

### BRIEF DESCRIPTION OF THE FIGURES

FIG. 1 illustrates a substrate treatment apparatus according to an embodiment of the present invention.

FIG. 2 is a perspective view of a treating solution injection portion shown in FIG. 1.

FIG. 3 is a cross-sectional view of an injection nozzle shown in FIG. 2.

FIG. 4 illustrates the steps of injecting a treating solution from the injection nozzle shown in FIG. 3.

FIG. 5 is a cross-sectional view of another type of a treating solution injection portion shown in FIG. 2.

FIGS. 6 and 7 are top plan views of a first nozzle portion shown in FIG. 5.

### DETAILED DESCRIPTION OF PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

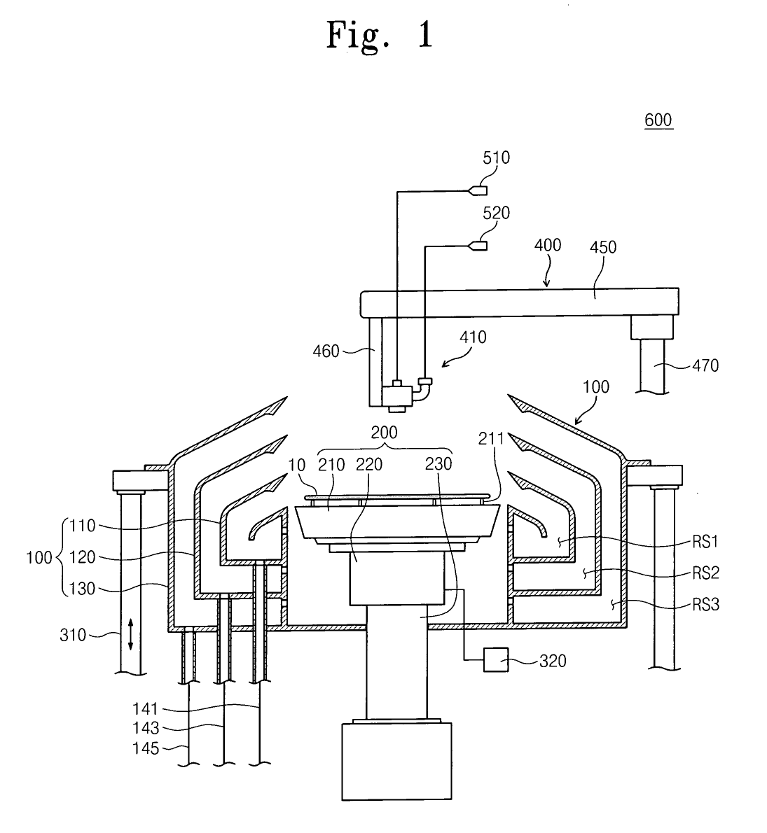

FIG. 1 illustrates a substrate treatment apparatus according to an embodiment of the present invention.

Referring to FIG. 1, a substrate treating apparatus 600 includes a treating vessel 100, a substrate supporting member 200, a vertical moving member 310, a rotating motor 320 and a treating solution supplying portion 400.

The treating vessel 100 includes first, second and third collection tubs having a cylindrical shape. In the present embodiment, the treating vessel 100 is constituted of three collection tubs 110, 120 and 130. However, the number of the collection tubs 110, 120 and 130 may be increased or decreased.

The first to third collection tubs 110, 120 and 130 collect a treating solution supplied to a wafer 10 during a treating process. That is, the substrate treating apparatus 600 treats the wafer 10 using the treating solution while the wafer 10 is rotated by the substrate supporting member 200. Thus, the treating solution supplied to the wafer 10 is scattered and the first to third collection tubs 110, 120 and 130 collect a scattered treating solution from the wafer 10.

More specifically, each of the first to third collection tubs 110, 120 and 130 includes a bottom surface having a ring shape and a sidewall of a cylindrical shape extended from the bottom surface. The second collection tub 120 surrounds the first collection tub 110 and is disposed to be separated from the first collection tub 110. The third collection tub 130 surrounds the second collection tub 120 and is disposed to be separated from the second collection tub 120.

The first to third collection tubs 110, 120 and 130 form first to third collection spaces RS1, RS2 and RS3 in which treating solution scattered from the wafer 10 flows. The first collection space SR1 is defined by the first collection tub 110 and collects a first treating solution which firstly treats the wafer 10. The second collection space SR2 is defined by a separated space between the first and second collection tubs 110 and 120, and collects a second treating solution which secondly treats the wafer 10. The third collection space SR3 is defined by a separated space between the second and third collection tubs 120 and 130, and collects a third treating solution which thirdly treats the wafer 10. The third treating solution may be rinsing solution which rinses the wafer 10.

In the embodiment stated above, each of the treating solutions is collected from the first tub 110 to third collection tub 130 in order according to a treatment process of the wafer 10 but a collecting order of treating solution of the first to third collection tubs 110, 120 and 130 may be changed according to a treating process and a location of the wafer 10.

Each of the first to third collection tubs 110, 120 and 130 has a top surface with an opened center. The top surfaces of the first to third collection tubs 110, 120 and 130 are downwardly inclined toward edges thereof. Accordingly, treating solution scattered from the wafer 10 is guided in the collection spaces RS1, RS2 and RS3 along top surfaces of the first to third collection tubs 110, 120 and 130.

The first collection tub 110 is connected to a first collection line 141. The first treating solution which is injected in the first collection space RS1 flows out through the first collection line 141. The second collection tub 120 is connected to a second collection line 143. The second treating solution which is injected in the second collection space RS2 flows out through the second collection line 143. The third collection tub 130 is connected to a third collection line 145. The third treating solution which is injected in the third collection space RS3 flows out through the third collection line 145.

The treating vessel 100 is combined with a vertical moving member 310 which changes a vertical location of the treating vessel 100. The vertical moving member 310 is disposed at an outer sidewall of the third collection tub 130 and moves the treating vessel 100 up and down when a vertical location of the substrate supporting member 200 is fixed. As a result, a relative vertical location between the treating vessel 100 and the wafer 10 is changed. Thus, the treating vessel 100 may have each of the collection spaces RS1, RS2 and RS3 collect a different kind of treating solution and contamination gas.

In the embodiment, the substrate treating apparatus 600 changes a relative vertical location between the treating vessel 100 and the substrate supporting member 200 by vertically moving the treating vessel 100. Alternatively, the substrate treating apparatus 600 may change a relative vertical location between the treating vessel 100 and the substrate supporting member 200 by vertically moving the substrate supporting member 200.

The substrate supporting member 200 is accommodated in the treating vessel 100. The substrate supporting member 200 includes a spin head 210, a rotation axis 220 and a fixed axis 230.

The spin head 210 has a circle plate shape and a top surface of the spin head 210 faces the wafer 10. A plurality of chucking pins 211 supporting the wafer 10 is provided on the top surface of the spin head 210. The chucking pins 211 fix the wafer 10 on the spin head 210 by chucking the wafer 10.

The rotation axis 220 is combined with a bottom surface of the spin head 210. The rotation axis 220 is connected to a rotation motor 320 and rotates with respect to a central axis by a rotation power of the rotation motor 320. A rotation power of the rotation axis 220 is transferred to the spin head 210. Thus, the spin heads 210 rotates and the wafer fixed to the spin head 210 rotates.

The rotation axis 220 is combined with the fixed axis 230. A portion of the fixed axis 230 is inserted into the rotation axis 220 and is combined with the rotation axis 220 using a plurality of bearings (not shown). Accordingly, the fixed axis 230 does not rotate and the rotation axis 220 only rotates.

The treating solution supplying portion 400 dries the wafer 10 by supplying the treating solution to the wafer 10. The treating solution supplying portion 400 includes a treating solution injection portion 410 which injects the treating solution to the wafer 10, a first moving portion 450 which horizontally moves the treating solution injection portion 410, a connection portion 460 which connects the treating solution injection portion 410 and the first moving portion 450 and a second moving portion 479 which vertically moving the treating solution injection portion 410. The first moving portion 450 is provided on an upper portion of the treating vessel 100 and disposed on an upper portion of the treating solution injection portion 410. The connection portion 460 is connected to a first portion of the first moving portion 450 and the connection portion 460 is combined with the treating solution injection portion 410 by extending from a bottom surface of the first moving portion 450 to a lower part. The second moving portion 470 extends from a second portion of the first moving portion 450 to face the connection portion 460 and installed at an outside of the treating vessel 100. The second moving portion 470 moves up and down to control a separated distance between the treating solution injection portion 410 and the wafer 10.

The treating solution injection portion 410 is connected to a chemical solution supplying portion 510 to receive the treating solution. The treating solution injection portion 410 is also connected to the gas supplying portion 520 to receive a treating gas. The treating solution and the treating gas are constituted of isopropyl alcohol and nitrogen gas, respectively. The treating solution injection portion 410 cleans the wafer 10 by injecting the treating gas and the treating solution at the same time. A separated distance and a relative location between the treating solution injection portion 410 and the wafer 10 are controlled by the first and second moving portions 450 and 470. As a result, an injection location of the treating solution injection portion 410 is controlled.

Hereinafter, referring to drawings, the treating solution injection portion 410 will be described in detail.

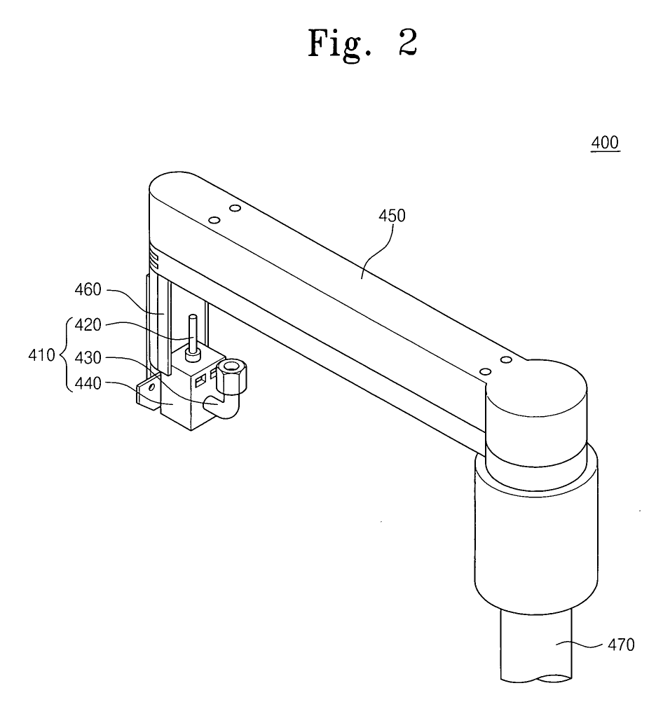

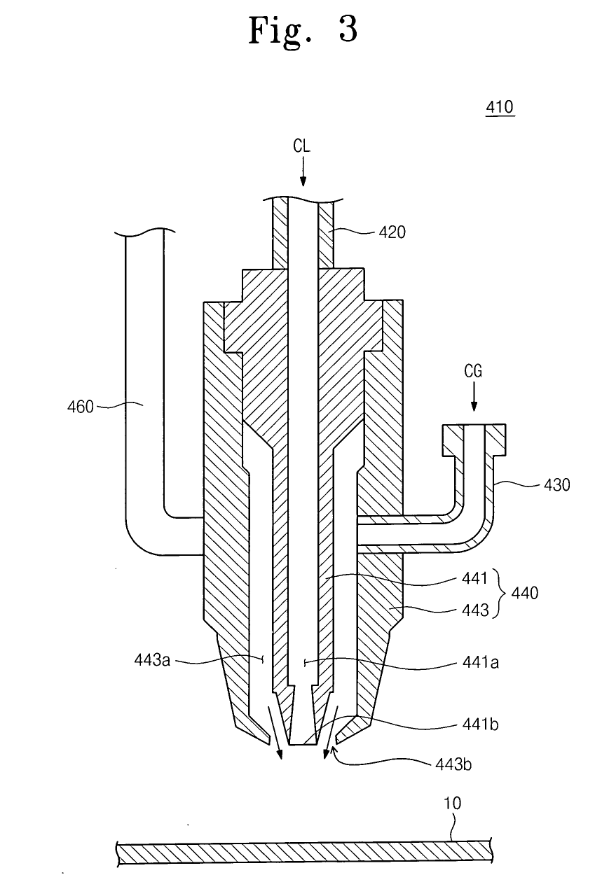

FIG. 2 is a perspective view of a treating solution injection portion shown in FIG. 1, and FIG. 3 is a cross-sectional view of an injection nozzle shown in FIG. 2.

Referring to FIGS. 1 and 2, the treating solution injection portion 410 includes a first supplying nozzle 420, a second supplying nozzle 430 and an injection nozzle 440.

The first supplying nozzle 420 is combined with a top surface of the injection nozzle 440 and connected to the chemical solution supplying portion 510. The first supplying nozzle 420 supplies the treating solution CL from the chemical solution supplying portion 510 to the injection nozzle 440.

The second supplying nozzle 430 is combined with one side of the injection nozzle 440 and connected to the gas supplying portion 520. The second supplying nozzle 430 supplies the treating gas CG from the gas supplying portion 520 to the injection nozzle 440.

Referring to FIGS. 2 and 3, the injection nozzle 420 is constituted of a first nozzle portion 441 receiving the treating solution CL and a second nozzle portion 443 receiving the treating gas CG. The first nozzle portion 441 has a cylindrical shape and is connected to the first supplying nozzle 420. A chemical solution flow path 441a through which the treating solution CL supplied from the first supplying nozzle 420 moves is formed in the first nozzle portion 441. A first injection hole 441b is formed at a lower portion of the first nozzle portion 441. The first injection hole 441b discharges the treating solution CL which is injected in the chemical solution flow path 441a to the outside.

The second nozzle portion 443 surrounds the first nozzle portion 441 and has a cylindrical shape. An upper portion of the second nozzle portion 443 is combined with the first nozzle portion 441. A one side of the second nozzle portion 443 is connected to the second supplying nozzle 430 to receive the treating gas CG from the second supplying nozzle 430. The second nozzle portion 443 is partially separated from the first nozzle portion 441, so that a gas flow path 443a in which the treating gas flows is formed between the first and second nozzle portions 441 and 443. A second injection hole 443b is formed at a lower portion of the second nozzle portion 443. The second injection hole 443b is formed in the shape of ring surrounding the first injection hole 441b and discharge the treating gas CG which is injected in the gas flow path 443a from the second supplying nozzle 430 to the outside.

A lower portion of the second nozzle portion 443 which defines the second injection hole 443b bends toward the first injection hole 441b. Thus, since a width of the second injection is smaller than a width of the gas flow path 443a, a treating gas pressure CG in the second injection hole 443b is higher than a treating gas pressure CG in the gas flow path 443a. Also, since a lower portion of the second nozzle portion 443 bends toward inside, the treating gas CG discharged from the second injection hole 443b is guided toward the first injection hole 441b.

A treating gas CG discharged from the second injection hole 443b is provided to a treating solution CL discharged from the first injection hole 441b and the treating solution CL discharged from the first injection hole 441b is decomposed into the shape of a minute particle. The minute particles are provided to a surface of the wafer 10 to dry the wafer 10.

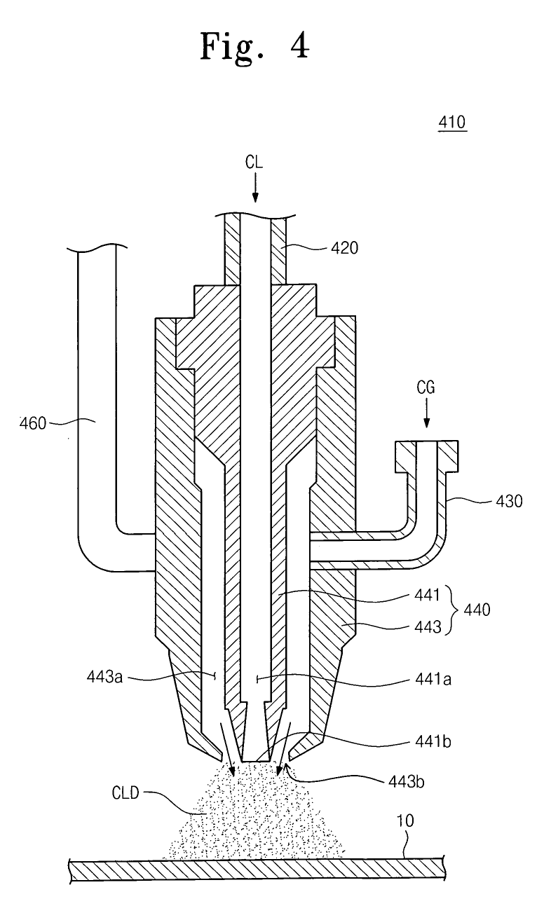

FIG. 4 illustrates the steps of injecting a treating solution from the injection nozzle shown in FIG. 3.

Referring to FIGS. 1 and 4, first, the wafer 10 is fixedly disposed on the spin head 210 and the treating solution injection portion 410 is disposed over the wafer 10.

The rotation axis 220 rotates by driving the rotation motor 320 and the spin head 210 rotates by a rotation power of the rotation axis 220, so that the wafer 10 rotates. The first supplying nozzle 420 of the treating solution injection portion 410 receives the treating solution CL from the chemical supplying portion 510 and provides the treating solution to the injection nozzle 440.

The injection nozzle 440 injects the treating solution CL into the wafer 10 which is rotating in the shape of a minute particle by discharging the treating gas CG and the treating solution CL at the same time, so that the wafer 10 is dried.

A process that the injection nozzle 440 injects the treating solution CL and the treating gas CG is as follows. First, the treating solution CL discharged from the chemical supplying portion 510 is provided to the first nozzle portion 441 of the injection nozzle 440 and is injected into the chemical solution flow path 441a of the first nozzle portion 441.

The treating gas CG discharged from the gas supplying portion 520 is provided to the second nozzle portion 443 of the injection nozzle 440 and is injected into the gas flow path 443a.

The treating solution CL which is injected in the chemical solution flow path 441a is discharged through the first injection hole 441b to the outside. At the same time, the treating gas CG which is injected in the gas flow path 443a is discharged through the second injection hole 443b to the outside. The treating solution CL discharged from the first injection hole 441b is decomposed into the shape of a minute particle by a pressure of the treating gas CG and provided to the wafer 10. As a result, the wafer 10 is cleaned.

When the second nozzle portion 443 discharges the treating gas CG, the second nozzle portion 443 injects the treating gas CG toward a path to which the treating solution CL is discharged from the first injection hole 441b since a lower portion of the second nozzle portion 443 bends toward inside. Thus, since the treating gas is sufficiently provided to the treating solution discharged from the first injection hole 441b, a size and the amount used of a minute particle of the treating solution CL are reduced and a diffusion rate of the treating solution CL is increased. Therefore, a cleaning efficiency and a productivity of the wafer 10 are improved and a manufacturing cost can be reduced.

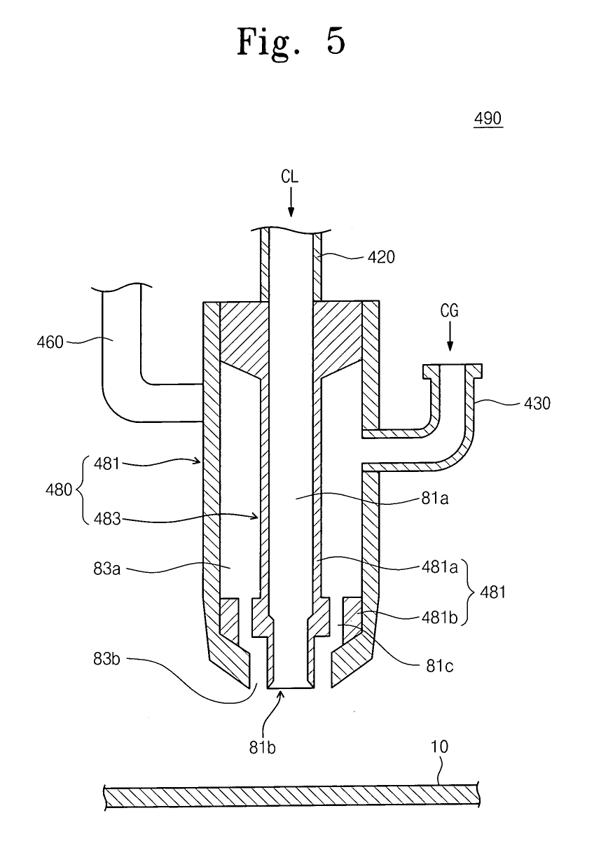

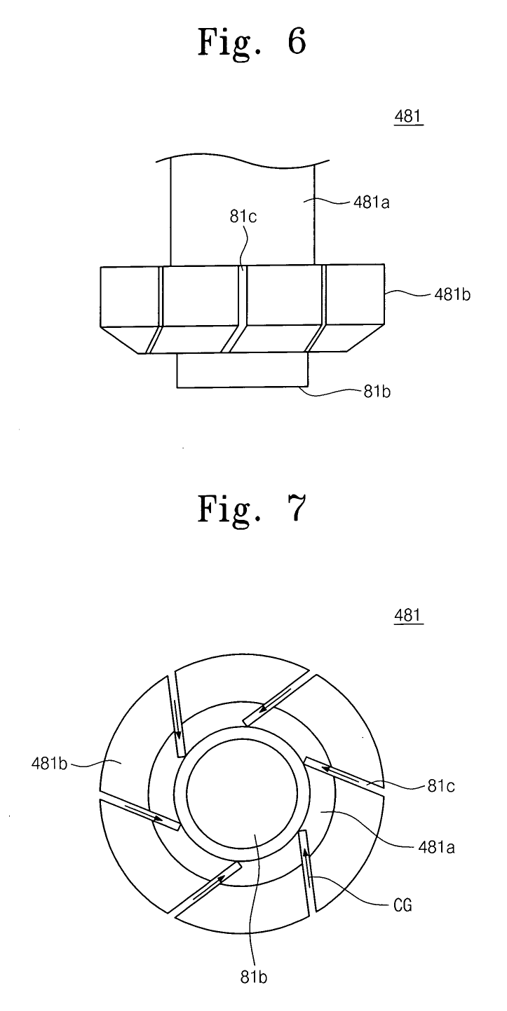

FIG. 5 is a cross-sectional view of another type of a treating solution injection portion shown in FIG. 2, and FIGS. 6 and 7 are top plan views of a first nozzle portion shown in FIG. 5. Specifically, FIG. 6 is a side view of the first nozzle portion 481, and FIG. 7 is a bottom plan view of the first nozzle portion 481.

Referring to FIGS. 5 and 6, a treating solution injection portion 490 includes first and second supplying nozzles 420 and 430, and an injection nozzle 480.

The first supplying nozzle 420 receives the treating solution CL from the chemical solution supplying portion 510 and provides the treating solution CL to the injection nozzle 480. The second supplying nozzle 430 receives the treating gas CG from the gas supplying portion 520 and provides the treating gas CG to the injection nozzle 480.

The injection nozzle 480 includes a first nozzle portion 481 which injects the treating solution CL and a second nozzle portion 482 which injects the treating gas CG.

More specifically, the first nozzle portion 481 includes a body portion 481a and a gas guide portion 481b. The body portion 481a has a cylindrical shape. An upper portion of the body portion 481a is connected to the first supplying nozzle 420 to receive the treating solution CL from the first supplying nozzle 420. A chemical flow path 81a through which the treating solution CL supplied from the first supplying nozzle 420 moves is formed in the body portion 481a. Also, a first injection hole 81b is formed in a lower portion of the body portion 481a. The first injection hole 81b discharges the treating solution CL which is injected in the chemical flow path 81a to the outside.

The gas guide portion 481b is formed in a lower portion of the body portion 481a. The gas guide portion 481b protrudes from an outer wall of the body portion 481a and a plurality of guide holes 81c controlling a stream of the treating gas is formed around the gas guide portion 481b.

The second nozzle portion 483 surrounds the first nozzle portion 481 and has a cylindrical shape. An upper portion of the second nozzle portion 483 is combined with the first nozzle portion 481. One side of the second nozzle portion 483 is connected to the second supplying nozzle 420 to receive the treating gas CG from the second supplying nozzle 420.

Also, the second nozzle portion 483 is partially separated from the first nozzle portion 481, so that a gas flow path 83a in which the treating gas CG flows is formed between the first and second nozzle portion 481 and 483. A second injection hole is formed at a lower portion of the second nozzle portion 483. The second injection hole 83b has a ring shape surrounding the first injection hole 81b and discharges the treating gas CG which is injected in the gas flow path 83a from the second supplying nozzle 430 to the outside.

The gas guide portion 481b is disposed to be adjacent the second injection hole 83b and is combined with an inner wall of the second nozzle portion 483. The treating gas which is injected in the gas flow path 83a is discharged through the second injection hole 83b to the outside after going by way of the guide holes of the gas guide portion 481b.

Referring to FIGS. 6 and 7, the guide holes are disposed to be separated from each other. The treating gas CG moves along the guide holes 81c and is injected through the second injection hole 83b. Since the guide holes 81c is disposed in the shape of a spiral structure with respect to the body portion 481a, a stream of the treating gas CG is formed in the shape of a spiral structure according to a shape of the guide holes 81c.

Therefore, since a treating gas CG discharged from the second injection hole 83b is guided to a flow path to which the treating solution CL is discharged, the treating solution CL is decomposed into the shape of a minute particle. The minute particle of the treating solution CL is provided to a surface of the wafer 10 to dry the wafer 10.

Since a stream of the treating gas CG is formed in the shape of a spiral by the guide holes 81c, the injection nozzle 480 can minimize a size of the minute particle of the treating solution CL, so that a diffusion rate of the treating solution CL is increased. Thus, the injection nozzle 480 improves a cleaning efficiency and a productivity of the wafer 10 and reduces a manufacturing cost. In the present embodiment, the guide holes 81c are disposed in the shape of a spiral structure. However, the guide holes 81c may be disposed in a radial shape with respect to the body portion 481a.

What is claimed is:

1. A substrate treating apparatus, comprising:
a supporting member on which a substrate is fixedly disposed; and
a treating solution supplying portion which is disposed above the supporting member and dries the substrate by injecting a treating solution in the shape of a minute particle on the substrate disposed on the supporting member,
wherein the treating solution supplying portion comprises:
a first supplying nozzle receiving the treating solution;
a second supplying nozzle receiving a treating gas; and
an injecting nozzle which simultaneously discharges the treating gas and the treating solution by controlling a stream of the treating gas to decompose the treating solution into a minor particle through the treating gas, the injecting nozzle including a chemical solution flow path in which the treating solution is injected from the first supplying nozzle and a gas flow path surrounding the chemical solution flow path in which the treating gas is injected from the second supplying nozzle.

2. The substrate treating apparatus of claim 1, wherein the injection nozzle comprises:
a first nozzle portion in which the chemical solution flow path and a first injection hole discharging the treating solution are formed, the first nozzle portion being connected to the first supplying nozzle; and
a second nozzle portion that the gas flow path is formed between the first nozzle portion and the second nozzle portion, and a second injection hole surrounding the first injection hole is formed to discharge the treating gas, the second nozzle portion surrounding the first nozzle portion and being connected to the second supplying nozzle.

3. The substrate treating apparatus of claim 2, wherein a lower portion of the second nozzle portion where the second injection hole is formed bends toward the first nozzle portion.

4. The substrate treating apparatus of claim 2, wherein the first nozzle portion comprises:
a body portion in which the chemical solution flow path is formed to be connected to the first supplying nozzle and has a cylindrical shape; and
a gas guide portion in which a plurality of guide holes changing a stream of the treating gas is formed, the gas guide portion being formed on an outer wall of the body portion, combined with an inner wall of the second nozzle portion, and disposed adjacent the second injection hole.

5. The substrate treating apparatus of claim 4, wherein the guide holes are located to be separated from each other and disposed in the shape of a spiral structure with respect to the body portion.

6. The substrate treating apparatus of claim 4, wherein the guide holes are located to be separated from each other and disposed in a radial shape with respect to the body portion.

7. A method for treating a substrate, comprising:
fixedly disposing a substrate on a supporting member;
disposing an injection nozzle on an upper portion of the supporting member; and
drying the substrate by injecting the treating solution in the shape of a minute particle through the injecting nozzle,
wherein drying the substrate comprises:
injecting a treating gas into a gas flow path of the injecting nozzle surrounding the chemical solution flow path and injecting the treating solution into a chemical flow path of the injecting nozzle; and
controlling a stream of the treating gas which is injected in the gas flow path to discharge the treating gas to the substrate and discharging the treating solution of the chemical solution flow path to the substrate to decompose the treating solution in the shape of a minute particle.

8. The method for treating a substrate of claim 7, wherein the treating gas is injected into a treating solution discharged from the injection nozzle by controlling a gas stream.

9. A method for treating a substrate, comprising:
fixedly disposing a substrate on a supporting member; and
providing an isopropyl alcohol to the substrate to dry the substrate, wherein the isopropyl alcohol is provided to the substrate in the shape of a spray using a treating gas.

10. The method for treating a substrate of claim 9, wherein drying the substrate comprises:
disposing an injection nozzle on an upper portion of the supporting member; injecting the isopropyl alcohol into a chemical flow path of the injecting nozzle and injecting the treating gas into a gas flow path of the injecting nozzle surrounding the chemical solution flow path; and
controlling a stream of the treating gas which is injected in the gas flow path to inject the treating gas into the substrate and discharging the isopropyl alcohol of the chemical solution flow path to the substrate to decompose the isopropyl alcohol in the shape of a minute particle.
